(19) United States
(12) Patent Application Publication
(10) Pub. No.: US 2012/0326585 A1
(43) Pub. Date: Dec. 27, 2012

(54) Drawer Closer

(75) Inventors: Steven T. Dorsey, St. Joseph, MN (US); Ray Caballero, Crystal, MN (US)

(73) Assignee: PRINCE CASTLE LLC., Carol Stream, IL (US)

(21) Appl. No.: 13/165,903

(22) Filed: Jun. 22, 2011

(51) Int. Cl. A47B 88/04; F03G 1/06

(52) U.S. Cl. 312/319.1; 185/37

(57) ABSTRACT

A cabinet with sliding drawers has a mechanism for applying motive force in a first direction. The motive force is obtained from motion of the mechanism in an opposite second direction. The mechanism includes a cam and a cam follower. The cam includes a first part, a second part and an inflection point between the first part and the second part. The cam follower engages with the cam. The cam follower is configured to store mechanical energy responsive to translation of the follower and cam relative to each other in the second direction along the first part. The cam follower is also configured to apply motive force in the first direction to urge the follower to continue translation in the second direction along the second part. The motive force is applied after the follower passes the inflection point.

### FIELD

This disclosure generally relates to sliding drawers, and more particularly to mechanisms to assist in closing sliding drawers.

### BACKGROUND

Cabinets and other storage units that include drawers typically include drawer slides to provide assistance in moving the drawer between a closed position within the cabinet body and an open position with the drawer extending outward from the cabinet body. The drawer slides are typically mounted in pairs having one on the left side and the other on the right side of the drawer. Some drawer slides include bearings, such as ball or roller bearings, disposed between the drawer slide members to provide for smooth movement of the drawer and to assist in opening and closing the drawer.

While drawer slides can assist in opening and closing drawers, there are some instances in which additional assistance is desirable in closing drawers. For example, heavier drawers may still require a substantial amount of force to close the drawer, which is undesirable. Additionally, in some applications, it may be desirable to ensure that the drawer is fully closed. As such, a method and apparatus to assist in closing drawers and to ensure that drawers are fully closed is desirable. Typically, if one of the drawers in a cabinet is not fully closed, you cannot open another one.

### BRIEF DESCRIPTION OF THE DRAWINGS

The present disclosure is illustrated by way of example and is not limited by the accompanying figures, in which like references indicate similar elements. Elements in the figures are illustrated for simplicity and clarity and have not necessarily been drawn to scale.

FIG. 1 is an example of an isometric view of a storage unit having a drawer closer according to the present disclosure.

FIG. 2 is an example of a side view of the storage unit.

FIG. 3 is an example of an exploded view of the drawer closer.

### DETAILED DESCRIPTION

Example embodiments of a drawer closing apparatus are described herein. In the following description numerous specific details are set forth to provide a thorough understanding of the embodiments. One skilled in the art will recognize, however, that the techniques described herein can be practiced without one or more of the specific details, or with other methods, components, materials, etc. In other instances, well-known structures, materials, or operations may not be shown or described in detail to avoid obscuring certain aspects.

Reference throughout this specification to “one embodiment,” “an embodiment,” “one example,” or “an example” means that a particular feature, structure or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures or characteristics may be combined in any suitable combinations and/or subcombinations in one or more embodiments or examples. In addition, it is appreciated that the figures provided herewith are for explanation purposes to persons ordinarily skilled in the art and that the drawings are not necessarily drawn to scale. Furthermore, unless stated otherwise, terms such as “first” and “second” are used to arbitrarily distinguish between the elements such terms describe. Thus, these terms are not necessarily intended to indicate temporal or other prioritization of such elements.

In one example, a mechanism, such as a drawer closer, is disclosed for applying motive force in a first direction. The motive force is obtained from motion of the mechanism in an opposite second direction. The mechanism includes a cam and a cam follower. The cam includes a first part, a second part, and an inflection point between the first part and the second part. The cam follower engages with the cam. The cam follower is configured to store mechanical energy responsive to translation of the follower and cam relative to each other in the second direction along the first part. The cam follower is also configured to apply motive force in the first direction to urge the follower to continue translation in the second direction along the second part. The motive force is applied after the follower passes the inflection point.

The mechanism provides, among other advantages, assistance in closing drawers when the follower passes the inflection point. Furthermore, the motive force ensures that the drawer fully closes when the follower passes the inflection point. Other advantages will be recognized by those of ordinary skill in the art.

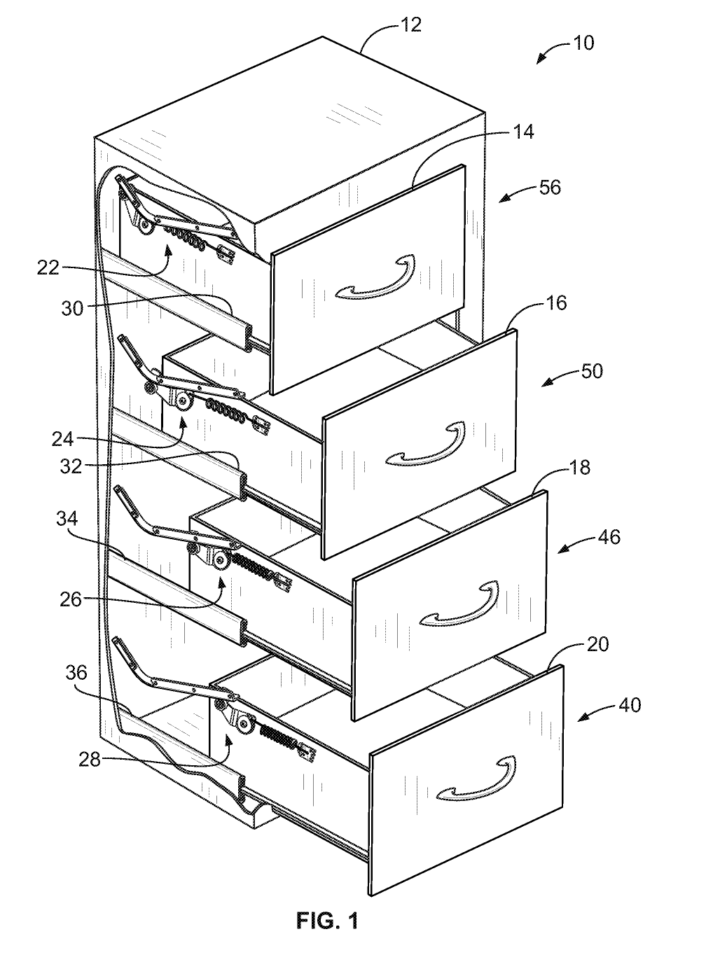

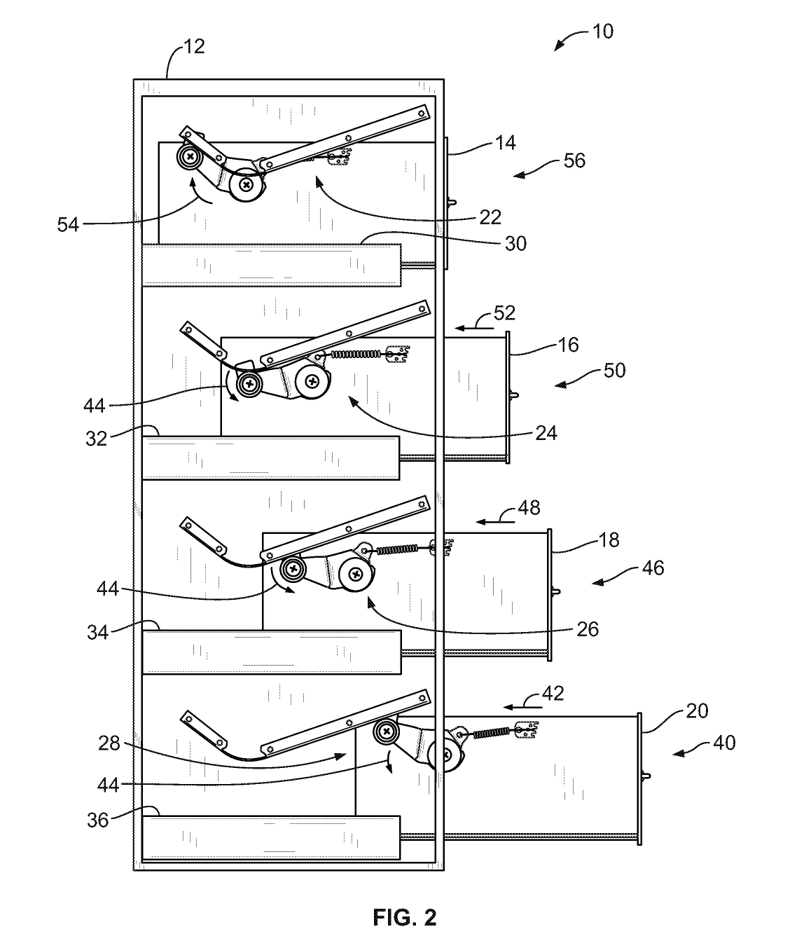

Referring now to FIGS. 1 and 2, an example of an isometric and side view of a storage unit 10 having a cutaway side is depicted. In this example, the storage unit 10 is depicted as a cabinet 12, however any suitable storage unit having one or more drawers can be used according to the present disclosure. The cabinet 12 includes a first drawer 14, a second drawer 16, a third drawer 18, and a fourth drawer 20. Although the storage unit 10 includes four drawers in this example, the storage unit 10 can include any suitable number of drawers (e.g., one or more) if desired.

Each drawer 14, 16, 18, 20 slides in and out of an internal portion of the cabinet 12 via a respective drawer slide 30, 32, 34, 36. The drawer slides 30, 32, 34, 36 are coupled between the cabinet 12 and a respective drawer 14, 16, 18, 20 such that each respective drawer 14, 16, 18, 20 can translate between an open position and a closed position relative to the cabinet 12 in response to an applied force (e.g., compressive and/or tensile forces). Closing the drawer requires a compressive force, and opening the drawer requires a tensile force. The drawer slides 30, 32, 34, 36 can comprise any suitable drawer slide known in the art.

Each of the drawers includes a respective closing mechanism or drawer closer 22, 24, 26, 28. As discussed in further detail below, the closing mechanism 22, 24, 26, 28 applies motive force in a first direction from motion of the mechanism in an opposite second direction.

As shown in this example, each drawer 14, 16, 18, 20 is in a different state of closure. More specifically, in this example, drawer 14 is fully closed, drawer 16 is partially open, drawer 18 is more partially open than drawer 16, and drawer 20 is fully open. As shown, each drawer 14, 16, 18, 20 includes a respective drawer closer 22, 24, 26, 28.

The term “cam” is defined in the Merriam-Webster's Collegiate Dictionary as a rotating or sliding piece, such as an eccentric wheel or a cylinder with an irregular shape, in a mechanical linkage and used to transform rotary motion into linear motion or vice versa. As used herein, the term “cam” refers to an elongated rail that is curved or inflected and attached to either the side of a drawer or the side of a cabinet. When such a cam is attached to a drawer, the cam is stationary with respect to the drawer but movable with respect to a cabinet. When such a cam is attached to a cabinet, the cam is fixed or stationary relative to the cabinet and movable relative to a drawer.

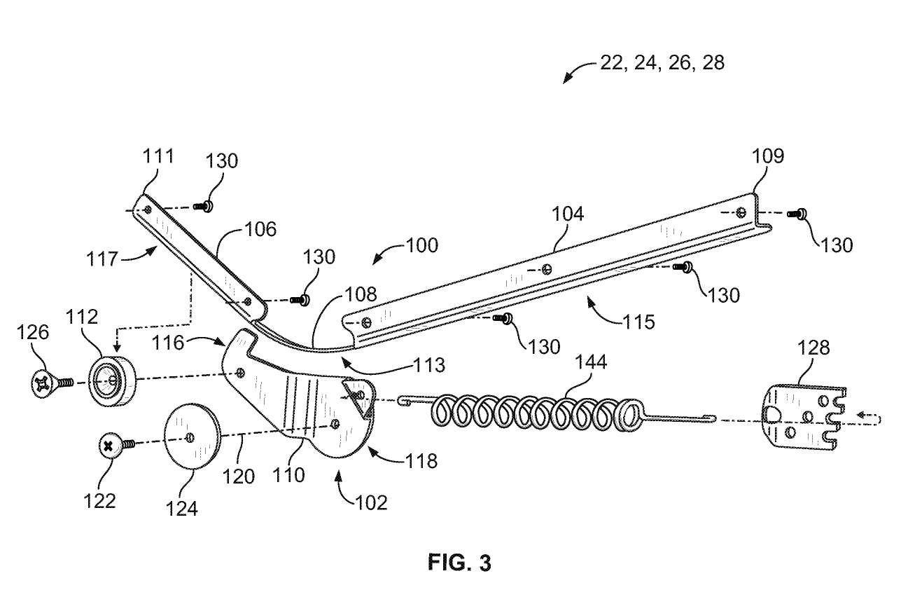

Referring now to FIG. 3, an example of an exploded diagram of the drawer closer 22, 24, 26, 28 is depicted. The drawer closer 22, 24, 26, 28 includes a cam 100 and a cam follower 102. The cam 100 includes a substantially linear first part 104, a substantially linear second part 106, and an inflection point 108 in a centrally-located curved portion 113. The inflection point 108 is where the slope of the cam 100 and the slope of the curved portion 113 changes direction. The inflection point 108 is disposed between the first part 104 and the second part 106. As shown in this example, the cam 100 has an elongated surface with a first end 109 and an opposite second end 111. The inflection point 108 is between the first end 109 and the second end 111 but not necessarily half-way or mid-way between the first end 109 and the second end 111. As such, the first part 104 of the cam 100 can be defined by the first end 109 and the inflection point 108 while the second part 106 can be defined by the inflection point 108 and the second end 111.

The cam 100 is also comprised of the aforementioned curved portion 113, which is located between the first part 104 and the second part 106. As shown, the curved portion 113 is formed by an arc that comprises the inflection point 108. In some embodiments, the arc can open upwardly such that the first part 104 is a declined part and the second part 106 is an inclined part, as referenced from the front of the cabinet and with respect to horizontal. In other embodiments, the arc can open downwardly such that the first part 104 is an inclined part and the second part 106 is a declined part as referenced from the front of the cabinet and with respect to horizontal. Or stated another way, the cam is comprised of a curved portion between two inclined parts (104 and 106), or two declined parts (104 and 106) relative to the inflection point.

In one alternate embodiment, the first part 104 is straight while the second part 106 is at least slightly curved. In another alternate embodiment, the first part 104 is curved while the second part 106 is straight. In yet another embodiment, the first part 104 and the second part 106 are both curved. The first part 104 and the second part 106 are separated from each other by the inflection point 108.

The first part 104 includes a first inclined planar portion 115 having a first length and a first angle of inclination relative to horizontal. In one embodiment, the first angle of inclination can be between about five degrees and ten degrees with a preferred embodiment being about ten degrees. The second part 106 includes a second inclined planar portion 117 having a second length and a second angle of inclination relative to horizontal. In one embodiment, the second angle of inclination can be between about twenty degrees and thirty degrees with a preferred embodiment being about twenty-six degrees. In some embodiments, the first and second angles of inclination can be different angles.

The first and second lengths are selected to determine a location along the length of travel where a closing force is applied to the drawer 14, 16, 18, 20 by the respective drawer closer 22, 24, 26, 28. The lengths of the first part 104 and the second part 106 and the length of the curved part 108 will depend on the length of the drawer and drawer slide. In one embodiment, the first and second lengths are different lengths.

The term “cam follower” is used herein to refer to a roller, a surface or a bearing that follows, rides over or rides along the cam. The cam follower 102 includes a lever 110, a roller 112, and an energy storage device 144. The lever 110 includes a first end 116 and a second end 118. The first end 116 and the second end 118 pivot around axis 120, which is located between the first end 116 in the second and 118. The axis 120 can be formed via any suitable means. For example, in one embodiment, the axis 120 can be formed via a screw 122 and/or a washer 124. In this example, the screw 122 passes through the washer 124 and screws into one of the respective drawers 14, 16, 18, 20 to form the axis 120.

When assembled, the cam follower 102 engages with the cam 100 via the roller 112 and stores mechanical energy via the energy storage device 144, which in one embodiment is a coil spring. More specifically, the energy storage device 144 stores mechanical energy in response to translation of the cam follower 102 and the cam 100 relative to each other in a first direction along the first part 104. The cam follower 104 is configured to release stored mechanical energy (via the energy storage device 144) in an opposite second direction after the roller 112 translates past the inflection point 108 to urge the cam follower 104 to continue translation along the second part 106.

A coil spring, which has been stretched by a distance or an amount “x,” has an elastic potential energy of an amount equal to ½k×², where k is the spring constant of the spring. The spring constant of the spring is determined by the amount of force that it takes to stretch the spring a certain amount. Therefore, according to Hooke's Law, the force F=−kx or k=−F/x.

When assembled, the roller 112 is attached to the first end 116 of the lever 110 via an attachment part 126. The roller 112 is configured to engage the cam 100 and rotate the lever 110 around the axis 120 in response to translation of the cam follower 102 relative to the cam 100. The energy storage device 144 is coupled to the second end 118 of the lever 110 and is configured to store mechanical energy in response to a substantially linear translation of the cam follower 102 relative to the cam 100.

The cam 100 and cam follower 102 are configured such that translation of the cam follower 102 along the first part 104 toward the inflection point 108 causes the cam 100 to exert a correspondingly increasing force against the roller 112, which rotates the lever 110 around the axis 120 in angular direction tensioning (stretching) the energy storage device 144. The continued translation of the cam follower 102 and cam 100 relative to each other along the first part 104 causes the roller 112 to pass the inflection point 108, which in turn enables a force stored in the energy storage device 144 to rotate the lever 110 around the first axis in a second angular direction opposite the first angular direction. The rotation of the lever 110 in the second angular direction causes the roller 112 to exert force against the cam 100, which urges the cam follower 102 to continue traveling toward the second end 111 and away from the inflection point 108.

In one embodiment, the attachment part 126 can comprise a screw and/or any other suitable attachment part. In one embodiment, the energy storage device 144 can comprise a spring, an elastic band, and/or any other suitable energy storage device. When assembled, the energy storage device 144 is attached to the second end 118 of the lever 110 and an anchor portion 128. In one embodiment, the anchor portion 128 is attached to one of the respective drawers 14, 16, 18, 20 via any suitable known means such as via a screw, for example. In other embodiments, the anchor portion can be formed in one of the respective drawers 14, 16, 18, 20.

In some embodiments, the cam 100 is fixed (e.g., stationary) and the cam follower 102 translates relative to the cam 100. As such, the cam 100 is coupled to an interior portion (e.g., cubby) of the cabinet 12 in which the drawer slides via any suitable attachment means, such via screws 130 for example. In one example, the cam 100 can be formed in the interior portion of the cabinet 12 if desired. In other embodiments, the cam follower 102 can be fixed (e.g., stationary) and the cam 100 can translate relative to the cam follower 102.

Referring back to FIGS. 1 and 2, as shown at position 40, the drawer 20 is in a fully open position. As a drawer 20 slides in direction 42, the cam follower 102 engages with the cam 100 and begins to rotate around the axis 120 moving the cam follower 102 in a first angular direction 44. In response thereto, the energy storage device 144 begins to build up and store energy.

At position 46, the drawer 18 is in a first partially open position. As shown, the drawer 18 is moving in direction 48 and the roller 112 of the cam follower 110 is approaching the inflection point 108 of the cam 100. As such, the energy storage device 144 is building up and storing energy as the drawer 18 traverses in direction 48.

At position 50, the drawer 16 is in a second partially open position, which is further closed than the first partially open position. As shown, the drawer 16 is moving in direction 52 and the roller 112 of the cam follower 110 has substantially reached the inflection point 108. The energy storage device 144 reaches a maximum energy storage when the roller 112 is positioned substantially at the inflection point 108. Once the roller 112 passes the inflection point 108, the energy storage device 144 begins to release stored potential energy as kinetic energy and pulls the drawer 16 closed rotating the cam follower 102 around the axis 120 in a second angular direction 54 opposite the first angular direction 44. More specifically, the roller 112 engages the second part 106 of the cam 100 and traverses the second part 106 pulling the drawer 16 and direction 52 until the drawer 16 is fully closed.

At position 56, the drawer 14 is fully closed and the roller 112 has traversed to its resting position along the second part 106 of the cam 100. In addition, the energy storage device 144 has remaining energy stored therein, which holds the drawer 14 closed and ensures that the drawer 14 is fully closed.

As noted above, the drawer closer 22, 24, 26, 28 provides, among other advantages, assistance in closing drawers when the cam follower 102 passes the inflection point 108. Furthermore, the force stored in the energy storage device 144 ensures that the drawer fully closes when the cam follower 102 passes the inflection point 108. Other advantages will be recognized by those of ordinary skill in the art, including the use of the drawer closer disclosed above in a horizontal orientation or plane wherein one of the cam 100 and the follower 102 are attached to the bottom of a drawer with the other one of them attached to a cabinet frame.

Although the disclosure is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

What is claimed is:

1. A mechanism for applying in a first direction, motive force obtained from motion of the mechanism in an opposite second direction, the mechanism comprised of:
a cam having a first part, a second part and an inflection point between them; and
a cam follower engaged with the cam, the cam follower being configured to store mechanical energy responsive to translation of the cam follower and cam relative to each other.

2. The mechanism of claim 1, wherein the cam follower is configured to store mechanical energy responsive to translation of the cam follower and cam relative to each other in the second direction along the first part and wherein the cam follower is additionally configured to apply motive force in the first direction, to urge the cam follower to continue translation in the second direction along the second part, the motive force being applied after the follower passes the inflection point.

3. The mechanism of claim 1, wherein the cam and cam follower comprise a drawer closer.

4. The mechanism of claim 2, wherein the cam follower is comprised of a lever, a roller and a spring, the lever having first and second ends and pivoting around a first axis located between the first and second ends, the roller being attached to the first end of the lever, the spring being attached to the second end of the lever, the roller being configured to engage the cam and rotate the lever around the first axis responsive to translation of the cam follower relative to the cam, the spring being coupled to the second end of the lever and configured to store and release mechanical energy responsive to the substantially linear translation of the follower relative to the cam.

5. The mechanism of claim 3, wherein the cam and cam follower are configured such that translation of the cam follower along the first part and toward the inflection point causes the cam to exert a correspondingly increasing force against the roller, which rotates the lever around the first axis in a first angular direction thereby tensioning the spring, continued translation of the cam follower and cam relative to each other in the first direction such that the cam follower passes the inflection point thereby enabling force stored in the spring to rotate the lever around the first axis in a second angular direction opposite the first angular direction, rotation of the lever in the second angular direction causing the roller to exert force against the cam and which urges the cam and cam follower to continue to travel in said first direction away from the inflection point.

6. The mechanism of claim 2, wherein the cam is an elongated surface having first and second ends and wherein the inflection point is between the ends, the first part of the cam being defined by the first end and the inflection point, the second part of the cam being defined by the inflection point and the second end.

7. The mechanism of claim 5, wherein the cam is further comprised of a curved portion between the first part and second part, the curved portion being formed by an arc, the arc being comprised of the inflection point.

8. The mechanism of claim 6, wherein the first part is comprised of a first inclined planar portion having a first angle of inclination relative to horizontal.

9. The mechanism of claim 6, wherein the second part is comprised of a second inclined planar portion having a second angle of inclination relative to horizontal.

10. The mechanism of claim 6, wherein the first part is comprised of a first inclined planar portion having a first angle of inclination, the second part is comprised of a second inclined planar portion having a second angle of inclination and wherein the first and second angles of inclination are different from each other.

11. The mechanism of claim 6, wherein the arc opens upwardly.

12. The mechanism of claim 6, wherein the arc opens downwardly.

13. The mechanism of claim 2, wherein the cam is fixed and the follower translates relative to the cam.

14. The mechanism of claim 2, wherein the follower is fixed and the cam translates relative to the cam.

15. A storage unit comprised of:
a cabinet;
a drawer;
at least one drawer slide coupled between the cabinet and drawer, the at least one drawer slide configured to enable the drawer to translate between an open position and a closed position relative to the cabinet; and
a drawer closer coupled between the cabinet and drawer, the drawer closer comprised of:
a cam having a first part having an inclined part and a declined part relative to the front of the drawer and an inflection point between them; and
a cam follower being configured to store and release mechanical energy responsive to translation of the cam follower over the inclined and declined parts, relative to the cam, translation of the cam follower relative to the cam corresponding to translation of the drawer into and out of the cabinet.

16. The storage unit of claim 15, wherein the follower is comprised of a lever, a roller and a spring, the lever having first and second ends and pivoting around a first axis of rotation, the roller being attached to the first end of the lever, the spring being attached to the second end of the lever, the roller being configured to engage the cam and rotate the lever around the first axis of rotation responsive to translation of the drawer relative to the cabinet, the spring being coupled to the second end of the lever and configured to store and release mechanical energy responsive to translation of the drawer relative to the cabinet.

17. The storage unit of claim 15, wherein the cam is further comprised of a curved portion between the inclined part and the declined part referenced to the front of the drawer, the curved portion forming an arc, which is comprised of the inflection point, wherein the inclined part is comprised of a first planar portion having a first length and a first angle of inclination, the declined part is comprised of a second inclined planar portion having a second length and a second angle of inclination, the first and second angles of inclination being different from each other.

18. The storage unit of claim 17, wherein the first and second lengths are selected to determine a location along the length of travel where a closing force is applied to the drawer by the drawer closer.

19. The storage unit of claim 15, wherein the cam is attached to the cabinet and the cam follower is attached to the drawer.

20. The storage unit of claim 15, wherein the cam is attached to the drawer and the cam follower is attached to the cabinet.

21. A method of closing an open drawer in a cabinet, the drawer traveling in the cabinet between a first open position and a second closed position on at least one drawer slide, the method comprising the steps of:
applying a first closing force to the drawer, when the drawer is in the first open position, the closing force causing the drawer to translate from the first open position toward the second closed position;
storing energy from the first closing force in a spring, which is tensioned by the translation of the drawer toward the second closed position; and
after the drawer translates past a third position located between the first open position and the second closed position, applying a second closing force to the drawer, the second closing force being supplied by energy stored in the spring.
